(19) United States
(12) Patent Application Publication
(10) Pub. No.: US 2007/0067252 A1
(43) Pub. Date: Mar. 22, 2007

(54) Archiving and data integration system

(75) Inventors: Arne Hengerer, Erlangen (AT); Gudrun Zahlmann, Neumarkt (DE); Misha Pivovarov, Marblehead, MA (US); Ralph Weissleder, Peabody, MA (US)

Correspondence Address: BRINKS HOFER GILSON & LIONE, P.O. BOX 10395, CHICAGO, IL, 60610, US

(73) Assignees: Siemens Aktiengesellschaft; The General Hospital Corp. d/b/a Massachusetts General Hospital

(21) Appl. No.: 11/214,637

(22) Filed: Aug. 30, 2005

(51) Int. Cl. G06F 17/30

(52) U.S. Cl. 707/1

(57) ABSTRACT

A system and computer software for archiving image and other data relating to medical research, having the capability to store images in digital imaging and communication in medicine (DICOM) format. The images are retrievable using pointers contained in a relational data base where the image data is associated with experiments and projects and the access to the DICOM data is controlled through a hierarchical system of access control related to the project organization and administration. The computer servers and mass storage are linked by a local area network and a wide area network, permitting collaboration by persons a geographically dispersed locations.

### TECHNICAL FIELD

The present application relates generally to relational databases for storing and retrieving information. More particularly the application relates to systems and methods for storage, management, retrieval and analysis of imaging and bioinformatics data in a client-server environment.

### BACKGROUND

Informatics is the study and application of computer and statistical techniques to the management of information. Bioinformatics includes the development of methods to search databases quickly, to analyze data retrieved by the database search, and to present the results to the user.

Increasingly, research is shifting from the laboratory bench to the computer desktop. Aids to research include advanced quantitative analyses, database comparisons, and computational algorithms to explore the relationships between diverse data types, which may be located at physically dispersed locations.

One use of bioinformatics involves managing and an analyzing data resulting from the clinical workflow. Such data may include genomic data such as sequence data SNPs, proteomic data and metabolomic data. “-omics” is a neologism referring to a field of study in biology ending in the suffix “-omics”, such as genomics or proteomics. It may be expected that the diagnosis of disease and a custom tailored therapy regime for each patient will be selected based on integrated patient data (i.e., imaging, pharmacogenomic data and proteomic data) that are analyzed using dedicated knowledge based decision support tools. For this, a data processing and storage system is required which is able to store, integrate and analyze various medical data.

Small animal imaging systems can generate significant amounts of data.

For example, dedicated mouse MRI and CT systems generate an average of 1.5 GB of data per day, although peak rate of data generation can be much higher.

Such images may be in DICOM (Digital Imaging and Communications in Medicine) or other formats. In addition, there is a growing need to store data which may be associated with imaging studies, for example histology, pathology, immunohistochemistry, in situ hybridization, gels, microarrays or mass spectroscopy data. Many research projects require database queries and searches of protein structures (e.g. Entrez Protein), chemical data banks (e.g. Chembank, Pubchem) or other archives (e.g. Pubmed, GenBank). Further, expanding multidisciplinary and multi-institutional research environments continue to foster collaborative projects, generating the need for organized and accessible shared data repositories.

Typical information management systems, such as electronic laboratory notebooks or image archives, are either too cumbersome, limited to certain computer platforms, too slow or not fully adapted to handle the large number, types, and size of data files. Clinical data management systems based on Picture Archiving and Communication Systems (PACS) or electronic patient records can be highly efficient but may be too expensive for routine deployment in a research environment. Typically such systems are optimized for handling of specific data and may have links to other systems but without effective integration of data models.

### BRIEF DESCRIPTION OF THE DRAWINGS

FIG. 1 is a block diagram illustrating an embodiment of the archiving and data integration system;

FIG. 2 is a screen shot illustrating a group of experiments organized as a project;

FIG. 3 is a screen shot illustrating the control of access by a hierarchy of privileges.

FIG. 4 is a screen shot illustrating the display of a series of thumbnails related to a specific study.

FIG. 5 is a screen shot illustrating the display of a image selected from the thumbnails of FIG. 4;

FIG. 6 is a screen shot illustrating a form which may be used for a power search of the data base; and

FIG. 7 illustrates a sample of data base search results for a project.

### DESCRIPTION

Exemplary embodiments may be better understood with reference to the drawings, but these embodiments are not intended to be of a limiting nature. Like numbered elements in the same or different drawings perform similar functions.

The combination of hardware and software to accomplish the tasks described herein is termed a platform. Where otherwise not specifically defined, acronyms are given their ordinary meaning in the art.

The instructions for implementing processes of the platform, the processes of the client application, the processes of a server, and/or the processes of the builder program are provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instruction set, storage media, processor or processing strategy and may be performed by software, hardware, integrated circuits, firmware, micro code and the like, operating alone or in combination. Likewise, processing strategies may include multiprocessing, multitasking, parallel processing and the like. In an embodiment, the instructions may be stored on a removable media device for reading by local or remote systems. In other embodiments, the instructions may stored in a remote location for transfer through a computer network, a local or wide area network or over telephone lines. In yet other embodiments, the instructions are stored within a given computer or system.

Methods, programs and systems are described for providing an interface for entering query information relating to one or more projects, locating data corresponding to the entered query information, and displaying the data corresponding to the entered query information. Provision is made for obtaining, converting and storing the necessary data, and for the archiving of such data. Further, the overall architecture makes provision for the various components to be geographically distributed while operating in a harmonious manner.

A flexible information technology (IT) platform is described for capturing, storing, archiving, managing, presenting and visualizing, searching, analyzing and mining molecular information (for example, DICOM images, histological-, biochemical—, and other experimental data) for research applications, such as contrast agent development and clinical applications. The platform may be Internet based, and use standard environments such as PACS for the management of images, extended by biochemical and bioinformatics data management and analysis tools. An experiment management layer and the visualization and processing of the data are included. The IT platform may also be used for translational research (such as contrast agent development, in vitro diagnostics development and therapeutic drug development), in clinical studies, or in a clinical environment.

The system may include the following elements and functionalities: a PACS and workstation for image viewing; secure access to the PACS via a web browser; ability to upload and the ability to download DICOM images; a connection to DICOM modalities; a connection to the clinical environment (e.g. MR-magnetic resonance imaging); a DICOM converter for non-DICOM modalities; development experiment management layer; an experiments management including experiment data management; control and management of user access rights; definition of data models; software for integrating images and other experimental data for analysis and display; development of visualization tools; software programs for management of -omics data or other specialized data types; and software tools for integrating clinical data. It will be appreciated that this recitation of elements and functionalities is intended to convey an appreciation for the types of elements and functionalities which may be present, however not all of the elements and functionalities may be found in a specific embodiment.

Various diagnostic data may be available from a single user interface, or the data may be dispersed at multiple locations. The combination of the data may be provided for a comprehensive data analysis by a researcher or a CAD (computer aided diagnosis) system.

To support multiple users at geographically distributed locations, a web-based platform has been developed with particular emphasis on the transmission, storage and retrieval of data sets. Where the term “web” or “Internet” is used, the intent is to describe an internetworking environment, including both local and wide area networks, where defined transmission protocols are used to facilitate communications between diverse, possibly geographically dispersed, entities. An example of such an environment is the world-wide-web and the use of the TCP/IP data packet protocol, and the use of Ethernet or other hardware and software protocols for some of the data paths.

The platform is web based and compatible with browsers such as those which may operate on Macintosh, Unix, Linux or Windows clients. The platform should may the capability for the storage of large amounts of data with fast access, and that the data be backed up at periodic intervals, such as daily. The platform may permit and facilitate storage of different file formats, including Digital Imaging and Communications in Medicine (DICOM), Tagged Image File Format (.tiff), Microsoft Office documents (.doc, .xls, .ppt) with little or no user intervention, and the uploading and the downloading of such data. The platform may provide facilities for data analysis and the storage of such analyzed data. The platform be configurable to follow the workflow of user organizations

Network Aspects

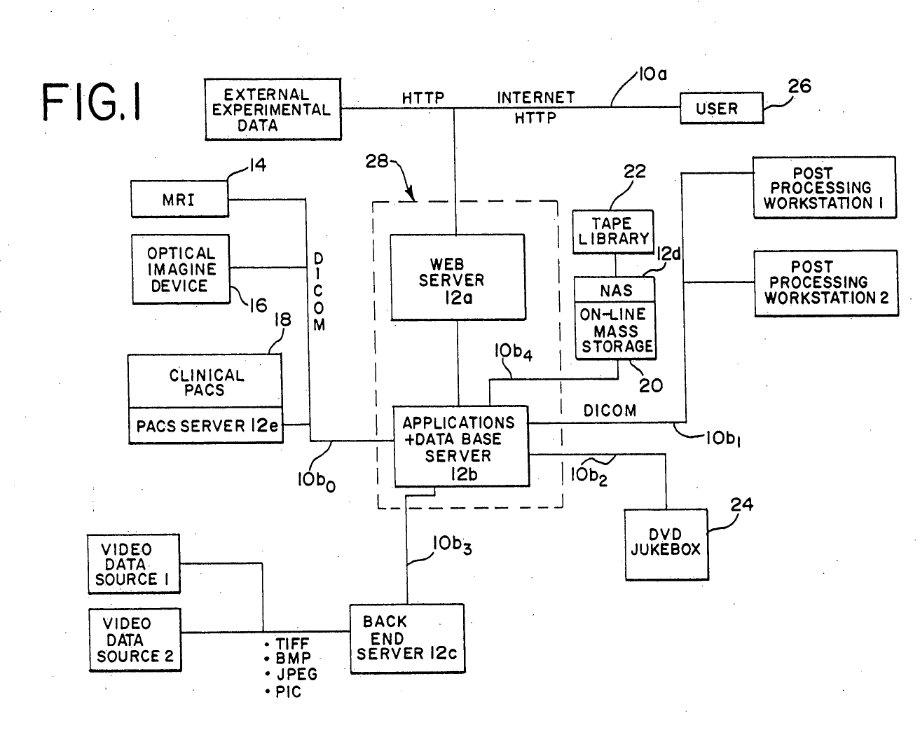

FIG. 1 depicts a network 10 interconnecting multiple computer systems 12a-e having a variety of functions and capabilities. The network may be a local area network (LAN) 10b, wide area network (WAN) 10a, which may be the Internet, or other network architectures, including wireless, optical and electronic transport devices and means. Network 10a, 10b permits a variety of computer-related operations to be divided amongst the computers, data bases and data acquisition and reproduction equipment using standardized or specialized protocols. The network may be divided into sub-networks (e.g. 10b₁, 10b₂) to manage the capacity and data flow in order to provide timely response to use requests. A LAN may be used to connect a variety of data collection equipment such as MRI 14, and CT, and optical systems supplying images in DICOM format from experimental or clinical environments including PACS 18 to a data base where the data is available for retrieval. Images that are not in DICOM format such as may be available from a microscope, bioluminescense assay or other optical or electronic instrument (shown in FIG. 1 as video data source 1 and video data source 2, may be converted from supported formats such as .tiff, .bmp, .jpeg, .pic into DICOM format for convenience in storage and retrieval. Mass storage on disk drives 20, on magnetic tape drives 22, or in DVD jukeboxes 24 may be attached to the network 10 as desired in the evolution of the system. Each of the data acquisition devices may be supported by a special purpose or general purpose post-processing workstation (shown in FIG. 1 as post processing workstations 1 and 2) communicating over the network 10 for manipulation of the data by operators. Data acquisition devices may not be collocated with the storage media, and data collected by these devices are forwarded to a computer at the data storage location by means of a network, which may be the world-wide web.

Access to the stored data in the database system is provided to users through devices such as personal computers and workstations configured as web clients (e.g. a user 26) and using the TCP/IP protocol suite.

Hardware

The hardware may be obtained from a variety of computer companies producing such products for server or storage applications. For example, the local server computers are obtained from the Hewlett-Packard Company, such as Application and Data Base Server 12b, PACS Server 12e, Network Attached Storage 12d, Back-End Server 12c, and Staging Server (not illustrated). The servers interface with a disk array 20, a tape library 22, a DVD Jukebox 22, a Web Server 12a and ancillary support systems as needed. A Dell computer with dual Intel® XEON 2.4 GHz Processors and 2 GB RAM is used as the Web Server 12a. More than one system function may be assigned to a specific computer, or the functions may be allocated to more than the computers described herein in accordance with the network architecture.

The Back-End Server 12c (e.g., HP DL320 G2 P3.06 GHz 2 GB RAM) operates on a Red Hat Linux operating system (obtained from Red Hat, Raleigh, N.C.) and is used for auxiliary services, such as a DICOM converter, and to support shared bioinformatics and chemoinformatics tools. A staging and testing server (e.g., HP DL320 G2 P3.06 GHz 2 GB RAM) may provide rapid prototyping and evaluation of changes to the system prior to actual implementation thereof.

The underlying PACS archive 18 is a Siemens MagicView 300 Archive (MV300), available from Siemens Medical Solutions, Malvern, Pa. The MV300 utilizes a HP DL320 server 12e with a Windows 2000 Server operating system. The MV300 is configured to automatically forward all incoming images to the platform local cache. A NSM 3000 DVD Jukebox 24, available from DISC Inc., Santa Clara, Calif., extends available storage to 3.5 TB. Up to 225 DVDs may be loaded to provide near-line storage. DVDs may be removed from the Jukebox and used as a long-term archive.

A HP StorageWorks NAS 2000s server 12d provides mass data storage. Using an independent storage facility may improve manageability and provide network accessible storage to a mix of clients and servers running different operating systems. An Intel Xeon 3.06 GHz processor as the NAS 2000s server 12d with 1GB of RAM is connected via SCSI interface to a disk enclosure 20 with 12 HP 250 GB SATA drives. This provides 3 TB (terabytes) of unformatted disk space which may be configured and to obtain 2.4 TB of usable space. The NAS 2000s server 12d supports up to four disk enclosures bringing the total storage to 12 TB. An HP MSL5030 tape library 22 with HP Open View Data Protector software provides automated backup capability.

Additional, different or fewer servers and data storage devices may be used. The specific types of equipment and software, manufacturers, product specifications and model numbers are given herein in order to illustrate an embodiment.

Software

A Microsoft IIS server was used for integration with the Microsoft.NET framework used for the data acquisition, data base server and browser-based ASP layers. The database server utilizes an Oracle 9.2 database engine. The Oracle database server is a relational database management system (RDBMS) that controls the organization, storage, retrieval, security and integrity of data and provides access via SQL queries. Image files are stored as binary objects in the database, or placed on a file system such with pointers maintained in the database. Login information, user preferences and access rights are also driven by relational database tables.

The access architecture is structured with hierarchical access privileges going from administrator, to PI (principal investigator), to investigator to technician to guest, each with definable privileges for a given project or experiment. While this terminology is typical for description of the hierarchy of a biomedical research organization system access protocol, other designations may be used at each level, with fewer or additional levels.

Platform independence may be achieved by using HTML, JavaScript and Java applet (image viewing) such that the client (e.g. web browser) may be executed on a wide variety of platforms as are and will be available for this purpose. Pages rendered by servers will be supported by all browsers and deliver similar user experience. XML may be used for data transfer with XSLT to render HTML pages. HTML pages may be rendered dynamically by ASP.Net. In addition, Web Forms, available from Microsoft, Redmond, Wash. is used to generate forms. Clients (users) communicate with the servers via a secure https (SSL encrypted) connection and use a HIPAA compliant authentication mechanism.

The DICOM converter in the Back End processor 12c is a collection of open-source libraries and tools. DICOM functionality is provided by “dicomlib” (by the imaging research group at Sunnybrook and Women's College Health Sciences Center, Toronto, Ontario). Image conversion and transformation is based on ImageMagick (by ImageMagick Studio LLC).

Connectivity

The platform connectivity may use a multiple network architecture. A primary network 10b allows access to the system from any computer on the internal network behind a firewall. The firewall may be established in the Web Server 12a or other hardware. Web clients may be connected via a Virtual Private Network (VPN), to provide secure connectivity to external collaborators 26. A secondary high-speed internal network (e.g. 10b₀) maximizes connectivity bandwidth between platform components. The DICOM data sources such as the MRI 14, the optical imaging device 16 and the PACS server 12e may utilize a secondary network 10b₀ via dedicated network adapters. A secondary network may also provide a convenient path to expand the system by splitting the web server, database server and application server onto individual hardware sub-platforms without creating network bottlenecks.

Images

DICOM file server software located in the NAS 2000s 12d is provided for image distribution. DICOM files can be previewed in a browser and downloaded as complete images, a series of images, or entire studies. Browser based image analysis tools include viewing and basic image manipulation. A built-in converter allows the user to convert, for example, tiff, bitmap and jpeg images into DICOM images to be stored on the PACS system. In addition, histology and confocal microscopy outputs in various formats may be stored and distributed.

Examples of Use

The platform may be used in conjunction with the workflow in a molecular imaging center. The top layer of infrastructure includes user defined projects. Each project can have multiple experiments, as defined by the user. Each experiment can hold DICOM images, other images files or a large number of non-image documents. The user may toggle among experiments, projects, or patient studies. Images can be downloaded as single images, series or entire studies. Preferences settings allow the user to define the layout of the displayed pages. An administrator tool allows a system administrator to add users, models, probes or other parameters.

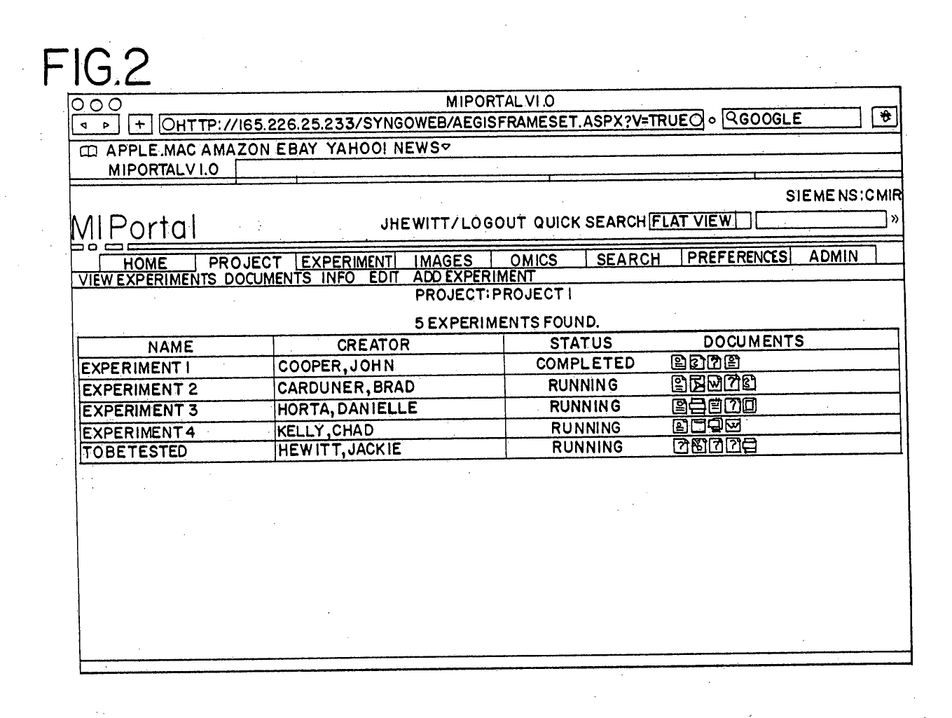

The overall architecture and typical use of the system and method is illustrated by screen shots, which provide an example of the user interface which may facilitate the interaction of users with the database. FIG. 2 is a screen shot which illustrates the organization of a project under the control of a principal investigator (PI) having a number of experiments, each of which has attributes, such as the experiment name, the person responsible for the experiment, the status of the experiment and icons indicating the types of data formats, and documents that have been associated with each of the experiments.

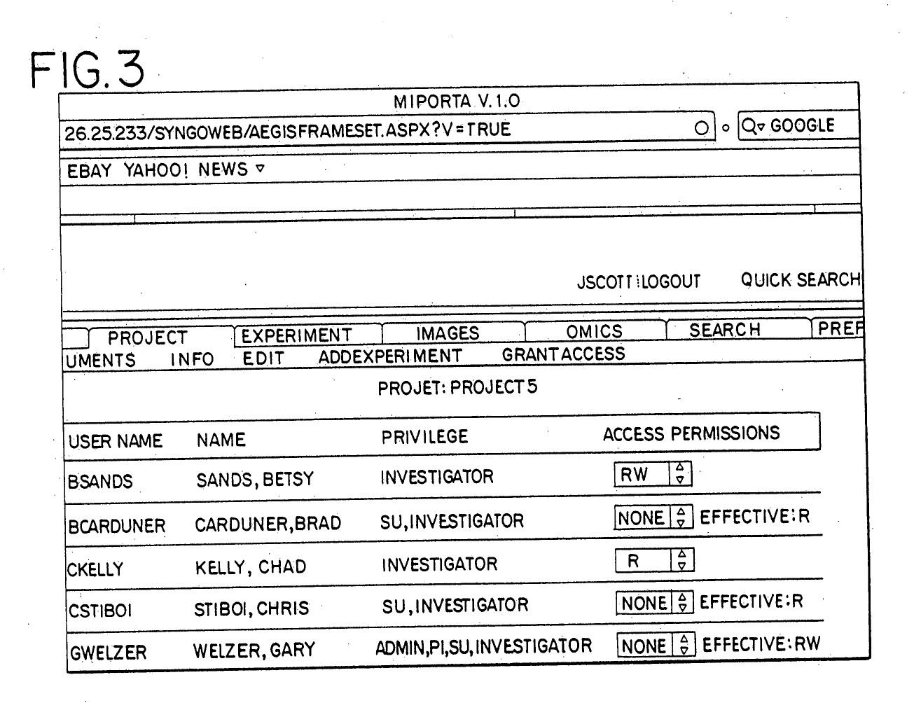

The PI can control access to the data base by granting access to users as shown in FIG. 3, where the user may be identified by a user name, actual name, privilege, associated with status in the experimental team, and the access privileges. When the permissions are set to “read-write (RW)”, the user is permitted to create experiments in the project and to add data to the database associated with the experiments.

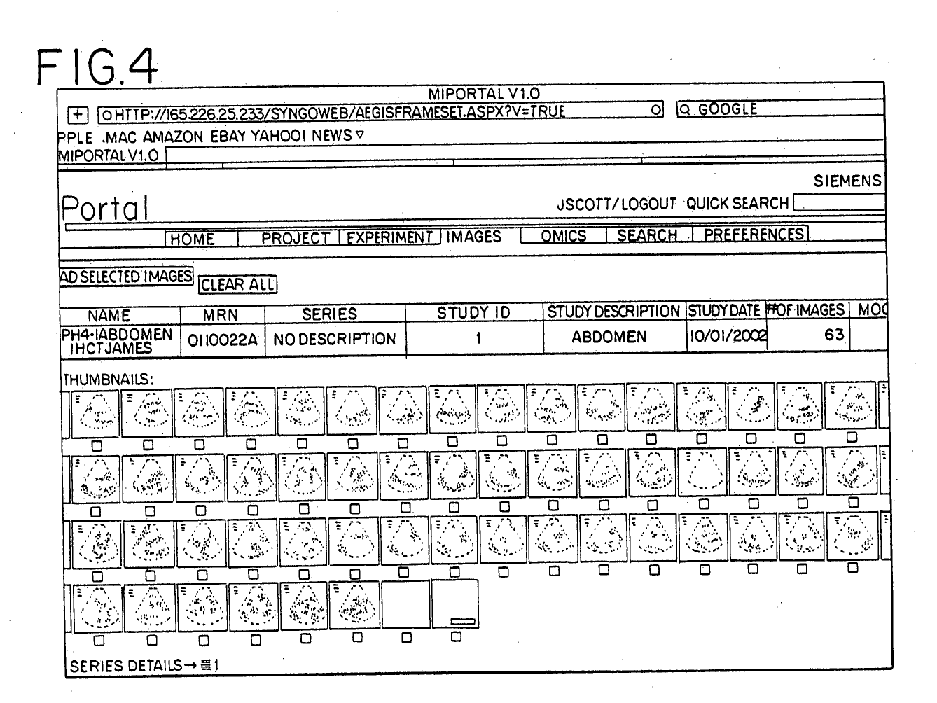

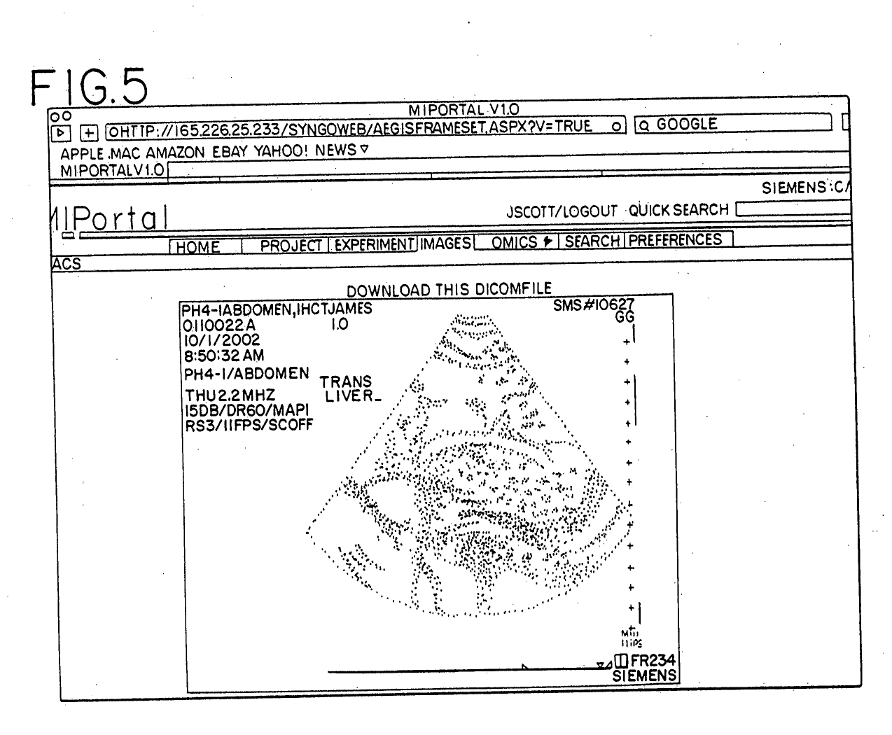

Images and other data obtained during the experiment are automatically forwarded from data collection or analysis tools such as PACS, and are associated with a specific experiment. The image data may be stored as image thumbnails for rapid display and review (FIG. 4), as well as full-scale images (FIG. 5). Individual images, entire series and studies are also available for download to a local hard drive on a desktop computer or the like which has a browser. The displayed images may be in JPEG format, and the stored images may be in the DICOM format. Depending of the desires of the user, a variety of analysis tools may be used for future viewing and processing of the locally stored data.

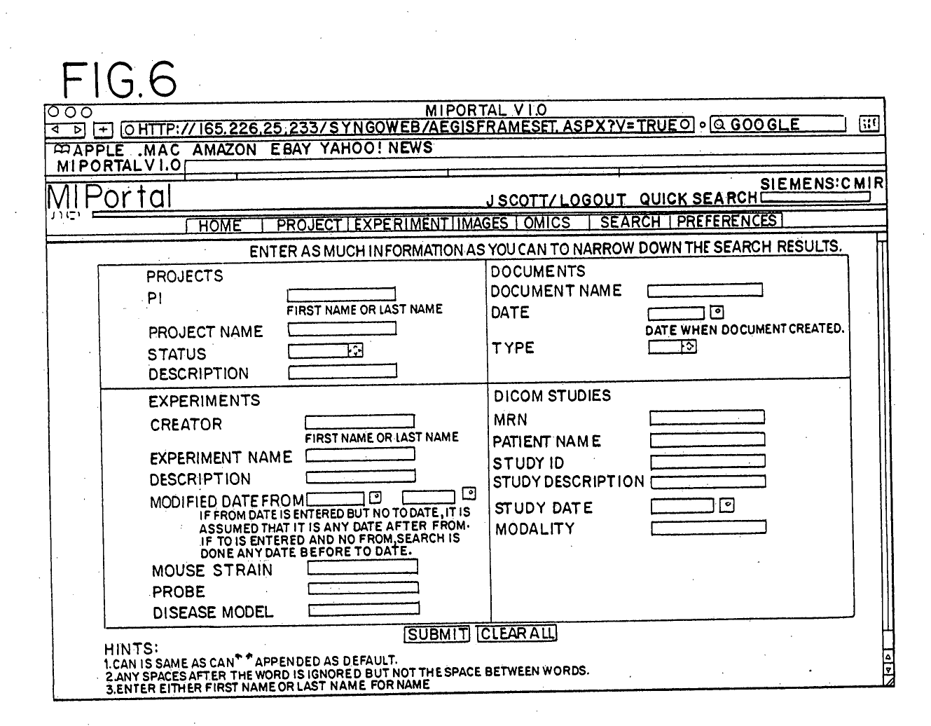

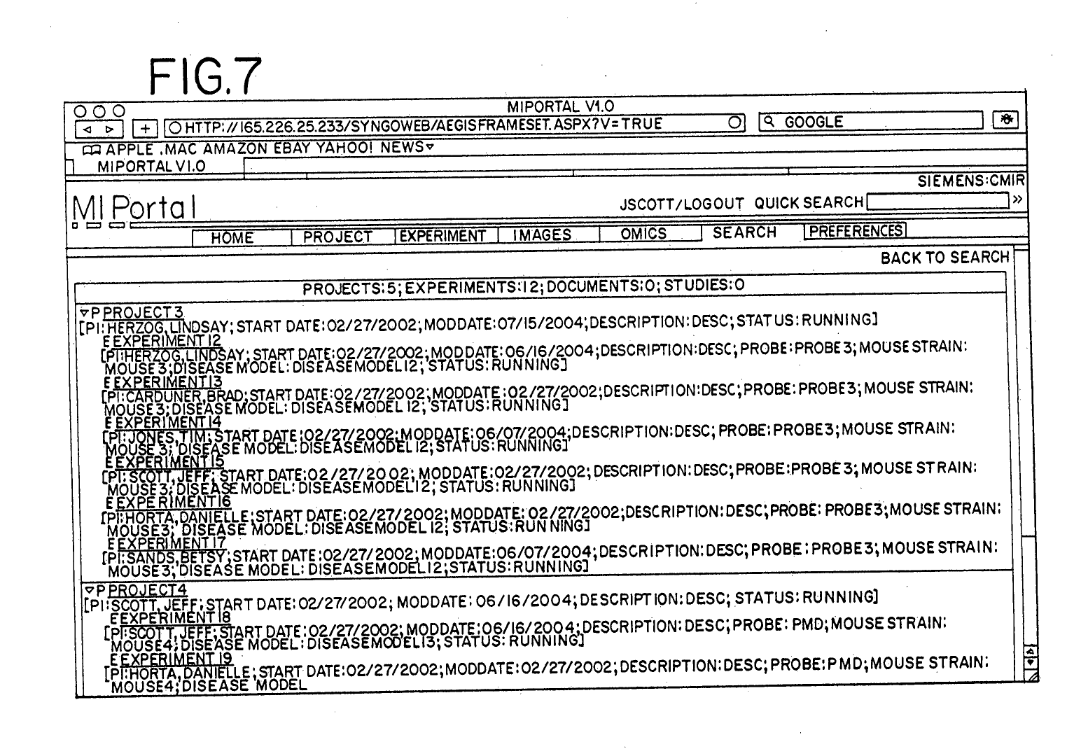

Examples of search strategies are: a) a quick search and b) a power search. The quick search allows a Google-style keyword search of the entire database. This search strategy returns a list (or a hierarchy) of projects, experiments, documents and for DICOM structures that produce a hit (or data match) for the keyword. Such a search is fast, convenient and may be made available from every page. The power search shown in FIG. 6 allows users to specify search criteria in a more precise and granular fashion. For instance, one can search for specific experiments, dates, investigators, medical record numbers or other fields. A result of the search is displayed to the user, an example of which is shown in FIG. 7.

Following are four example projects.

Single Institution Study With Emphasis on Image Analysis.

Raw MRI images are collected, and then quantitative image analysis is performed on large data-sets to derive angiogenic and tumor volume parameters from each primary tumor. Animals were studied serially or in cohorts such a groups of 30 mice, resulting in over 35,700 DICOM images. Following transfer to the platform, images are analyzed, and tumor volumes and vascularity determined in semi-automated fashion. Analyzed MR data is juxtaposed to immunohistochemistry.

Multi-Institutional Project.

Transgenic mice are followed for the development of orthotopic and metastatic tumors using a variety of imaging systems including MR, CT, SPECT and FMT imaging. Multiple major research institution may collaborate in the study. Mice are followed serially over 3-6 months and imaging studies associated with a given animal were stored within distinct “experiments”, all belonging to the same project. For example, the project contained over 40,000 CT images, SPECT, and optical images as well as histology and immunohistochemistry are obtained for each mouse. Autopsy data is uploaded into the system from the collaborating institution and investigators had real-time access.

Target Identification and Molecular Libraries.

Target identification may have multiple objectives such as, to perform, analyze and archive results of a phage display screen to identify novel peptide ligands and to acquire and store imaging studies to validate the developed agents in mouse models. Phage results are archived as MICROSOFT Excel and Treeview (provided by by Roderic D. M. Page, Division of Environmental and Evolutionary Biology, Institute of Biomedical and Life Sciences, University of Glasgow, Glasgow, Scotland, UK) files. Confirmatory Enzyme Linked ImmunoSorbent Assays (ELISAs) data may also uploaded. Fluorescence microscopy images of tissue microarrays are converted to DICOM files using the built-in image converter. Confirmatory imaging experiments may include MRI, endoscopic imaging and fluorescence imaging, stored within the project database set.

Clinical Trial.

For a clinical trial project, imaging studies are stored, analyzed and distributed for a prospective clinical trial involving magnetic nanoparticles, as an example of such a study. Imaging studies are acquired, such as through different MR (magnetic resonance) imaging systems distributed throughout the local environment. Multiple patients, such as 130 patients are enrolled in the trial. With an average of 900 images per patient, over 117,000 DICOM images are obtained. After image transfer from clinical scanners the images could then be accessed through password and user protected log-ins from within a VPN network. Download speed for query and transmission of 500 DICOM images (68 MB zipped file) through a DSL home network may be approximately 12 minutes compared with and Ethernet download time of 2 minutes, but other more rapid or slower transfer times may be experienced. The images are accessed through commercial DICOM viewers and used for analyses, image quantization, anonymization and read-outs.

It is therefore intended that the foregoing description be regarded as illustrative rather than limiting, and that it be understood that it is the following claims, including all equivalents, that are intended to define the spirit and scope of this invention.

What is claimed is:

1. A computer-readable storage medium having stored thereon: a relational database comprising:
a project table, containing experiment tables, the experiment tables specifying the types of stored data files associated with the experiment tables;
an access privileges table associated with the project table for controlling access to the project table;
a database search engine for identifying location of the stored data files corresponding to user defined search criteria; and
a computer program for retrieving the stored data files whose location has been identified by the search engine.

2. The computer-readable storage medium of claim 1, wherein the stored data files include at least image files stored in a separate data base.

3. The computer-readable storage medium of claim 1, wherein the image files are in digital imaging and communications in medicine (DICOM) format.

4. A computer system comprising:
(a) a database having a plurality of records, each of said records containing video images associated with an experiment in a project, wherein the image data is stored on media connected to the database through a computer network; and
(b) a user interface allowing a user to selectively view information regarding the experiment.

5. The computer system of claim 4, wherein the records include at least video files stored in a separate data base.

6. The computer-readable storage medium of claim 4, wherein the video files are in digital imaging and communications in medicine (DICOM) format.

7. The computer system according to claim 4, wherein the computer network comprises a local area network having a Internet server, the Internet server communicating with users by modulated signals on a carrier wave, the modulated signals having a TCP/IP format, and the users accessing the database and the media using a web browser.

8. A computer program product comprising a computer-usable medium having computer-readable program code embodied thereon relating to a plurality of records of image data, the records identifying the image data and associating the image data with a project and an experiment, the computer program product comprising computer-readable program code for effecting the following steps within a computing system:
(a) providing an interface for entering query information relating to a project and experiment;
(b) locating image data corresponding to the entered query information, the image data being located in a mass storage medium and a pointer to the location of the data being contained in a relational data base; and
(c) displaying the data corresponding to the entered query information.

9. The computer program product of claim 8, wherein the video images are located in a data base other than the relational data base.

10. The computer program product of claim 8, wherein the records of video images are in DICOM format or have been converted to DICOM format.
